(19) United States
(12) Patent Application Publication
(10) Pub. No.: US 2009/0247289 A1
(43) Pub. Date: Oct. 1, 2009

(54) Gaming machine having various functions

(75) Inventors: Arata Sugiyama, Las Vegas, NV (US); Norio Tone, Las Vegas, NV (US)

Correspondence Address: MASUVALLEY & PARTNERS, 8765 AERO DRIVE, SUITE 312, SAN DIEGO, CA, 92123, US

(73) Assignee: Konami Gaming, Inc., Las Vegas, NV (US)

(21) Appl. No.: 12/079,262

(22) Filed: Mar. 25, 2008

(51) Int. Cl. G06F 17/00

(52) U.S. Cl. 463/27

(57) ABSTRACT

The present invention is a gaming machine for providing a game after betting and for paying out an award according to a play result, including an initiator which executes the game, an assistant unit which helps a play in the game and a storage device which preserves the award as credits over 60.

### TECHNICAL FIELD

The present invention relates a gaming machine that is, in general, widely used in a casino. The gaming machine of the present invention has an assist function or flag function.

### BACKGROUND OF THE INVENTION

Functionality of a game provided by a conventional gaming machine in a casino, and an operation required for a player by the gaming machine have been monotonous, and consequently the gaming machine has tended to tire the player. Also, in some points such as story nature of a game, and images displayed in time with a game, a variety of gaming machines have been provided; however, there has been desired a gaming machine capable of providing new progress of a game, such as a gaming machine requiring a player to perform an operation based on a new idea to thereby enable the player to join the game. The gaming machine capable of providing such new progress of a game, such as the gaming machine enabling a player to join the game, can be found in, for example, Japanese published unexamined patent application No. 2007-029281.

### SUMMARY OF THE INVENTION

One aspect of the present invention may be a gaming machine for providing a game after betting and for paying out an award according to a play result, comprising an initiator which executes the game, an assistant unit which helps a play in the game and a storage device which preserves the award as credits over 60.

In the conventional game, the player only repeats the monotonous operation such as simply rotating reels, or only selecting a card. However, by configuring the gaming machine as above, the player can play a game, for example, according to an indicated sequence, or in consideration of a timing. This enables progress of the game, which has been monotonous, to be more active and fun, and does not tire the player. Also, there are various methods for assisting the player, so that such assisting methods can be combined, or a conventional way to play the game and some of the assisting methods can be combined to provide the player a wide variety of ways to play the game. Further, in a gaming machine requiring a somewhat skilled play technique, or the like, a wide-ranging game can be provided in terms of variety, for example, if some player requests to be assisted, the player can play the game with ease; however, a preset winning award amount becomes low. On the other hand, for another player not requesting to be assisted, the winning award amount is preset high.

The initiator may execute the game for selecting an object and the assistant unit may indicate a certain area including the object to help the player select the object. The initiator may execute the game for selecting an object and the assistant unit may indicate a certain object to get a better award for the player.

By configuring the gaming machine as above, an area in which the player selects an object can be reduced to thereby make the player feel advantageous, and simplify the game.

The initiator may execute the game for selecting an object and the assistant unit may indicate a better sequence that the player selects. The initiator may execute a reel game with a plurality of reels and the assistant unit may indicate a better sequence of the reel that the player stops.

By configuring the gaming machine as above, there can be provided a game configuration to the player, such as a configuration of a mini-game where if the player plays the game in the indicated sequence, he/she can win an award or the like. Also, the timing can be used to assist the player to thereby make the player feel rhythmical and put the player in a mind-set appropriate for the game.

The assistant unit may help the play by making a sound, emitting a light or displaying an image.

By configuring the gaming machine as above, various elements such as sound, light, and image can be used to assist the player in playing the game, so that the game becomes more wide-ranging in terms of variety, and therefore the player can be made to feel more active.

The difference of margin percentage between the award resulting from helping of the assistant unit and the award without help of the assistant unit may be about more than 4%.

By configuring the gaming machine as above, a difference between award amounts won by players having been assisted and not having been assisted can be clarified to some extent. Also, the game can be made more wide-ranging in terms of variety, for example, a player having taken some action can play a game capable of assisting the player, whereas another player not having taken the some action cannot play the game capable of assisting the player.

The initiator may execute a card game or a roulette game and the assistant unit may help the play in the card game or the roulette game.

By configuring the gaming machine as above, the player can be assisted in not only the reel game but also the card game or the roulette game, so that fun of the game can be made wide-ranging.

The initiator may execute a primary game and a secondary game and the assistant unit may help the play in the primary game.

By configuring the gaming machine as above, the player can be assisted in not only a bonus game or the like but also the primary game, so that fun of the game can be made wide-ranging

Another aspect of the present invention may be a gaming machine for providing a game after betting and for paying out an award according to a play result, comprising an initiator which executes the game demanding an operation for playing the game and an assistant unit which helps a timing to operate in the game.

In the conventional game, the player only repeats the monotonous operation such as simply rotating reels, or only selecting a card. However, by configuring the gaming machine as above, the player can play a game, for example, in consideration of a timing. This enables progress of the game, which has been monotonous, to be more active and fun, and does not tire the player. Also, there are various methods for assisting the player in terms of timing, so that such assisting methods can be combined, or a conventional way to play the game and some of the assisting methods can be combined to provide the player a wide variety of ways to play the game. Further, in a gaming machine requiring a somewhat skilled play technique, or the like, a wide-ranging game can be provided in terms of variety, for example, if some player requests to be assisted, the player can play the game with ease; however, a preset winning award amount becomes low. On the other hand, for another player not requesting to be assisted, the winning award amount is preset high.

The initiator may execute a reel game demanding to stop a reel and the assistant unit may help a timing to stop the reel. The initiator may execute a roulette game demanding to stop a roulette and the assistant unit may help a timing to stop the roulette. The initiator may execute a card game demanding to draw a card and the assistant unit may help a timing to draw the card.

The assistant unit may help the timing by making a sound, playing music, emitting a light or displaying an image.

By configuring the gaming machine as above, various elements such as sound, light, and image can be used to assist the player in playing the game, so that the game becomes more wide-ranging in terms of variety, and therefore the player can be made to feel more active.

The assistant unit may help the timing while playing the music.

By configuring the gaming machine as above, the player can be assisted in the play timing, in time to music. A rhythm game having been typically enjoyed as a game for home use, which uses a guitar, drum, or the like, is taken in a slot game for casino use, so that in addition to fun of winning an award or the like, fun of the home-use game can be enjoyed.

Another aspect of the present invention may be a gaming machine for providing a game and paying out an award, comprising a judgment which judges whether there is a player's winning inside the gaming machine or not, an announce unit, which declares the player's winning inside the gaming machine, a processor which evaluates whether the gaming machine receives a certain operation from the outside or not, after declaring the player's winning and a payout unit which pays the award outside the gaming machine in case the gaming machine receives the certain operation.

There has been a configuration so far in which every time the player wins, a payment is made back to the player so far. However, by configuring the gaming machine as above, winning outcomes can be stocked, so that, for example, a big winning award may be paid back at once, or on a portion-by-portion basis in the context of a play situation. Also, from a player side perspective, if a payback amount is small as compared with a past play history, the player can have various views, for example, the winning outcomes may be stocked inside the gaming machine, and therefore can further build up expectations for the game.

The certain operation may be to arrange a winning combination in the game, and the payout unit may pay the award outside the gaming machine in case the gaming machine receives the winning combination. The game may be a reel game or a card game.

The certain operation may be to be adapted a sequence selecting objects to an indicated sequence in the game, and the payout unit may pay the award outside the gaming machine in case the selecting sequence adapts to the indicated sequence. The game may be a game selecting objects like treasure, weapon or the other objects.

The certain operation may be to be adapted a timing selecting objects to an indicated timing in the game, and the payout unit may pay the award outside the gaming machine in case the selecting timing adapts to the indicated timing.

By configuring the gaming machine as above, there can be provided a game having a new sense where after the player has been convinced of winning, he/she is made to play the game.

### BRIEF DESCRIPTION OF THE DRAWINGS

FIG. 1 is a perspective view of an example of the gaming machine of the present invention.

FIG. 2 is a diagram illustrating an example of an “assistant” indicating a place a player had better select.

FIG. 3 is a diagram illustrating an example of an assistant indicating places a player had better select.

FIG. 4 is a diagram illustrating a case where the player has played according to the instruction of the assistant illustrated in FIG. 3.

FIG. 5 is a diagram illustrating an example of an assistant indicating a bonus game a player had better select.

FIG. 6 is a diagram illustrating an example of an assistant indicating a sequence in which a player had better make selections.

FIG. 7 is a diagram illustrating an example of an assistant indicating a sequence in which a player had better make selections.

FIG. 8 is a diagram illustrating an example of an assistant indicating a timing at which a player had better make a selection.

FIG. 9 is a diagram illustrating an example of an assistant indicating a timing at which a player had better a selection.

FIG. 10 is a diagram illustrating an example of the assistant indicating the timing at which the player had better make the selection.

FIG. 11 is a diagram illustrating an example of an assistant indicating a timing at which a player had better make a selection.

FIG. 12 is a diagram illustrating an example of the assistant indicating the timing at which the player had better make the selection.

FIG. 13 is a diagram illustrating an example of a method for informing a player of internal winning.

FIG. 14 is a diagram illustrating an example of the method for informing a player of internal winning.

FIG. 15 is a diagram illustrating an example of some sort of operation by a player.

FIG. 16 is an example of a flowchart for the gaming machine having the assist function.

FIG. 17 is an example of a flowchart for the gaming machine having the flag function.

FIG. 18 is another example of the flowchart for the gaming machine having the flag function.

### DETAILED DESCRIPTION OF INVENTION

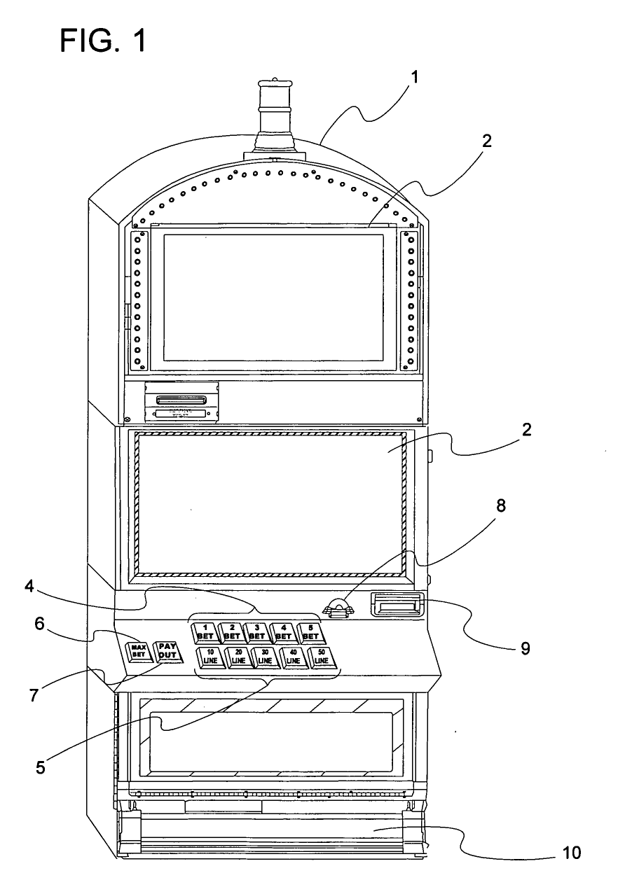

FIG. 1 is a perspective view illustrating an example of the gaming machine of the present invention. As illustrated in FIG. 1, a gaming machine 1 comprises two displays 2. Just below the lower one of the displays 2, a BET switch 4, select switch 5, MAXBET switch 6, PAYOUT switch 7, coin slot 8, and inlet/outlet for banknote or the like 9 are provided. The BET switch 4 has five switches from “1BET” to “5BET”. The select switch 5 has also five switches from “1select” to “5select”. Further, a coin payout port 10 is provided at the bottom of the gaming machine 1.

The display 2 provides a display necessary for a player to play a game. For example, the display 2 provides a display for playing a primary game or a secondary game. Also, the display 2 displays, for example, cards used in a card game, a roulette and coins used in a roulette game, or reels and features used in a reel game. Further, the display 2 provides a display for the player to select the type of a progressive game or bonus game, or that for the player to select the feature. Alternatively, the display 2 may display a progressive game screen, or the like, on which an amount of money a player may win is displayed. Still alternatively, the display 2 may display presentation according to progress of a game, a credit being inputted into the gaming machine by the player, a play history of the player, or the like.

The BET switch 4 is a switch for putting a bet in a game. The player uses the BET switch 4 to put any of the bets from “1BET” to “5BET” for a single play of the game. The select switch 5 is a switch for selecting, for example, a card the player would like to discard, a line on reels, or the like. The numbers of switches included in the BET switch 4 and select switch 5 are not limited to five, respectively, but may be any numbers. Alternatively, the gaming machine 1 may have, for example, a switch for betting “10BET”, or a switch for “10select”.

The MAXBET switch 6 is a switch for putting in the maximum bet that the player can bet on a single play of the game. The PAYOUT switch 7 is a switch for paying an amount of money credited to the gaming machine back to the player. The coin slot 8 is a hole for the player to credit coins to the gaming machine. The inlet/outlet for banknote or the like 9 is a hole used for inserting a banknote or cash card into the gaming machine, or for paying back an amount of credited money. The coin payout port 10 is intended for paying the amount of money credited to the gaming machine back to the player.

The gaming machine according to the present invention is not limited to the above, but may comprise various functions in addition to the above functions, or omit some of the above functions. For example, the gaming machine may have a lighting device for lighting the gaming machine with one or more different colors when the player enters the secondary game. Alternatively, the gaming machine may have a device for vibrating the entire game machine or outputting music when the player enters the secondary game. Still alternatively, the gaming machine 1 may have three or more displays. Yet alternatively, the gaming machine 1 may have a switch for again selecting “BET” the player bet on a previous play of the game.

Also, a reel, roulette, or the like used in the game is not necessarily displayed on the display, but the gaming machine 1 may be loaded with a stepper (mechanical reel), mechanical roulette, or the like. Further, there may exist a display used for a plurality of gaming machines in common.

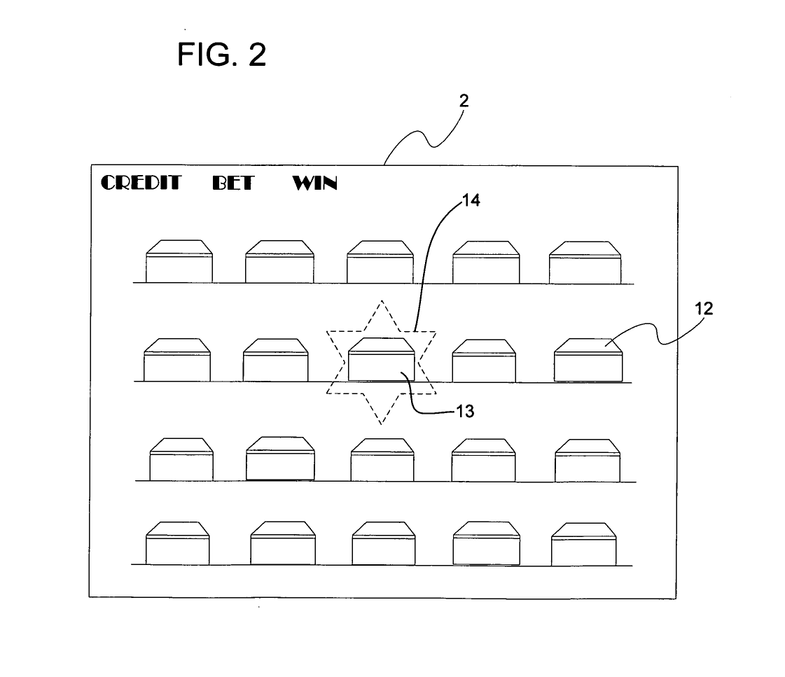

FIG. 2 is a diagram illustrating an example of an “assistant” indicating a place the player had better select. FIG. 2 illustrates the display screen 2. In FIG. 2, a game where the player selects a treasure box 12 is played. In each of the treasure boxes, an award the player may win is contained. The treasure box 13 is present within a star mark 14, and thereby adapted to be distinct. The game is configured such that if the player selects the treasure box 13, he/she can win a high amount of award. As described, the present invention assists the player in selecting the best place such that the player can win the high amount of award.

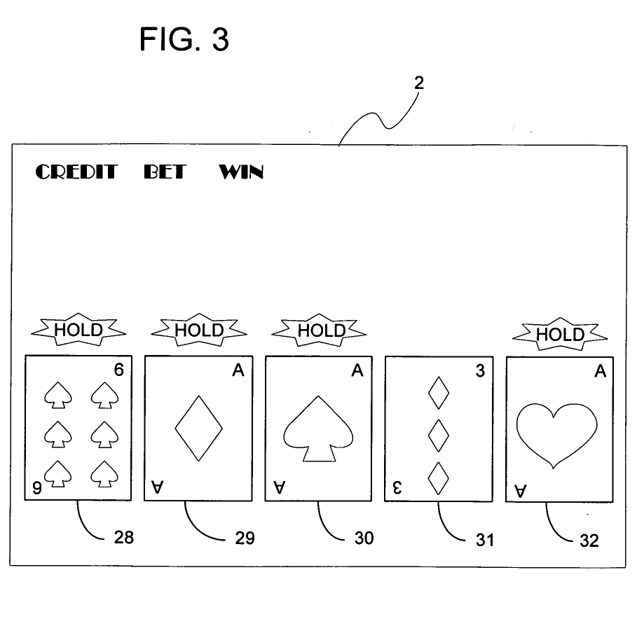

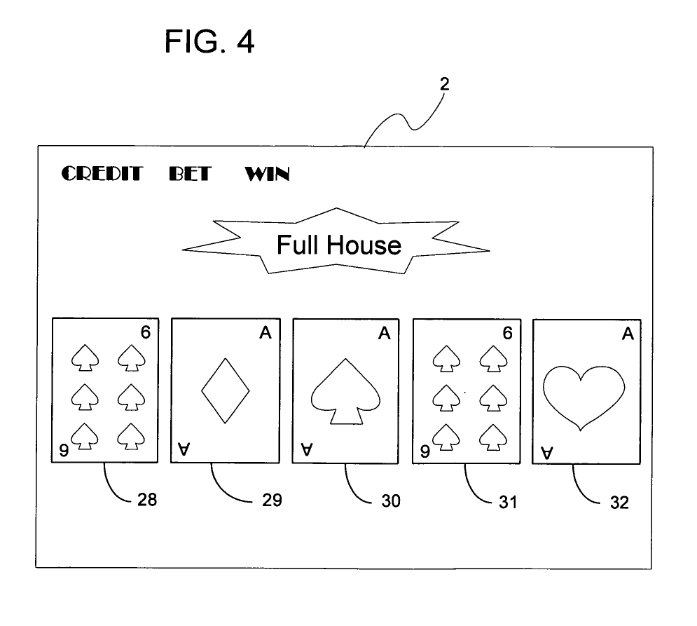

FIGS. 3 and 4 illustrate a poker game. FIG. 3 is a diagram illustrating an example of an assistant indicating places the player had better select. FIG. 3 illustrates the display screen 2. On the display screen 2, five cards 28 to 32 dealt to the player are displayed. In FIG. 3, the player is assisted by means of an instruction to hold the cards 28 to 30 and 32. If the player holds the cards other than the card 31 according to the instruction, the card 31 is only replaced, and a card arrangement as illustrated in FIG. 4 is provided.

FIG. 4 is a diagram illustrating a case where the player has played according to the instruction of the assistant illustrated in FIG. 3. FIG. 4 illustrates the display screen 2. On the display screen 2, five cards 28 to 32 the player has finally obtained are displayed. As can be seen from the five cards illustrated in FIG. 4, “Full House” is made. As described, the present invention assists the player in holding the best places so that the player can make a hand.

What is meant in FIGS. 3 and 4 is as follows: Which of the cards should be held after the deal of the five cards illustrated in FIG. 3 is dependent on a player. That is, “Three of a kind” has been made with three of the cards (29, 30, and 32), so that, some player would only hold the cards 29, 30 and 32. Another player would hold the card 28 or 31 in addition to the cards 29, 30, and 32. As described, if a way to replace a card is dependent on a player, the gaming machine assists a player by informing the player of the best way to replace a card as described with FIGS. 3 and 4.

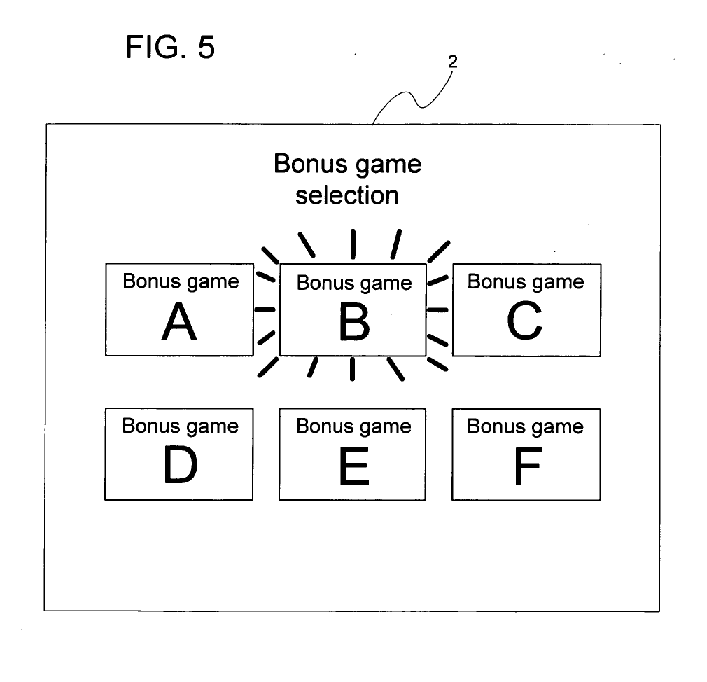

FIG. 5 is a diagram illustrating an example of an assistant indicating a bonus game a player had better select. FIG. 5 illustrates the display screen 2. On the display screen 2, a plurality of types of bonus games prompting the player to make a selection are displayed. In FIG. 5, a bonus game B lights to thereby assist the player in selecting the bonus game B. If the player selects the bonus game B, he/she can win the highest amount of award.

In FIGS. 2 to 5, the specific examples of the assisting method that indicates the place (or places) the player had better select are described; however, the present invention is not limited to these examples, but may be in any configuration if the configuration assists the player. For example, in FIG. 2, an object to be selected by the player is not the treasure box, but may be anything. For example, the object may be a picture of some sort of character, diamond, animal, household article, car, or the like. The number of objects (treasure boxes, etc.) may be any number. For example, the number of objects may be a small number such as three or five, or a large number such as twenty or thirty. What prompts the player to make a selection is not the star mark, but may be anything. For example, only an object to be selected may be blinked or colored to be thereby able to be distinguished from other objects. Alternatively, an indicator such as an arrow may appear to indicate the object to be selected. Still alternatively, the object may be adapted to be determined by the player on the basis of voice or the like. Yet alternatively, a character may be displayed to indicate the object the player had better select. The objects are not necessarily regularly arrayed in vertical and horizontal directions, but may be displayed in any arrangement. For example, the objects may be disorderly or irregularly displayed. Also, a plurality of objects may be displayed within some sort of shape such as a circular or star shape.

Also, in FIGS. 3 and 4, for example, the number of cards dealt to the player may be any number. For example, the number of dealt cards may be three (for three card poker) or four (for four card poker). Further, the poker game may be configured such that six or more cards are dealt to the player, and the player selects five of them. A card type used for the game may be any one. The “HOLD” marks are displayed when the player replace his/her cards; however, the cards to be held by the player may be displayed in any form. For example, rather than displaying the “HOLD” marks for the cards to be held by the player, a “Discard” mark may be displayed for the card to be discarded by the player. A hand of the poker is not limited to the “Full House”, but any hands such as “Straight” and “Flush” may be present. Also, a player's advantage when such hand is made may be arbitrarily defined from time to time.

Also, in FIG. 5, for example, the number and types of bonus games displayed on the selection screen may be any number and types, respectively. For example, weapon names may be used to allow the presence of the bonus game types such as a “Dagger bonus game”, “Machine-gun bonus game”, and “Rader bonus game”. Also, along with this, game content played in each of the various types of games may correspond to a title of the game. That is, in the “Machine-gun bonus game”, for example, the bonus game where a machine-gun is used may be played. The number of bonus games the player can select from such bonus games is not limited to one, but may be any number. For example, two or three of the bonus games may be selected, and after entrance of any of the bonus games, the plurality of types of bonus games may be played without returning to a primary game. The method for assisting the player in selecting the best game may be any one, and may be any of the ones described above. A game to be selected with the assistance is not only the bonus game, but any type of game may be selected with the assistance. For example, a game may be selected from a plurality of free games with the assistance. Also, a game may be selected with the assistance from a plurality of types of progressive games such as one where a payback amount is set large or small. Further, a game may be selected with the assistance from a group in which the bonus games, free games, progressive games, and other games are present together.

Also, the number of objects indicated by the gaming machine to assist the player is not limited to one, but may be any number. For example, the gaming machine may be adapted to indicate a plurality of objects including one the gaming machine desires the player to select, from which the player selects one. Also, it may be adapted to indicate the plurality of objects, from which the player selects several objects. The object indicated by the gaming machine is not limited to one containing the highest amount of award, but may be any one. The gaming machine may indicate, for example, an object containing the lowest amount of award, or representing a certain amount of award, an object by which some sort of point is given, a coupon ticket or the like is given, or a special game such as the bonus game is started, a display of a magnification ratio for multiplying a total amount of awards a player has won or will win, or the like. Also, the game type to be selected with the assistance of the gaming machine includes any one in addition to the above-described game types. For example, a game such as blackjack may be selected with the assistance of the gaming machine.

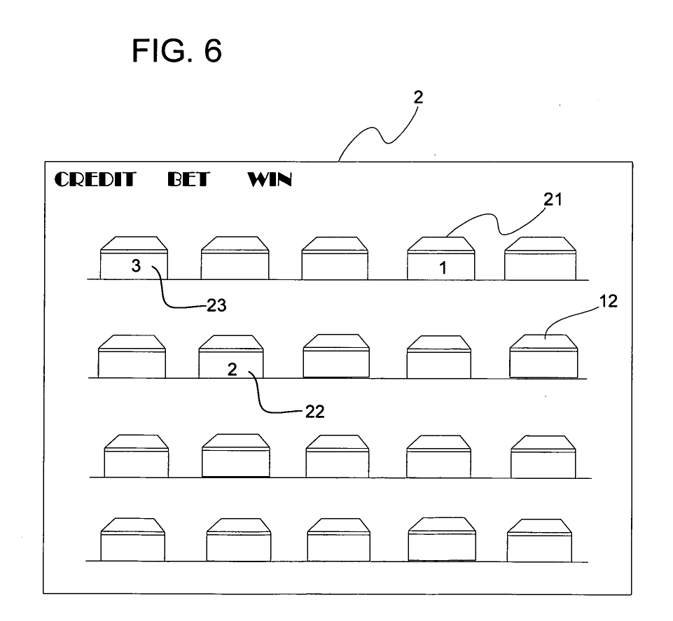

Next, a function of the gaming machine to assist a player in a sequence in which the player had better make selections is described. FIG. 6 is a diagram illustrating an example of an assistant indicating the sequence in which the player had better make selections. FIG. 6 illustrates the display screen 2. In FIG. 6, a game where the player selects three treasure boxes 12 is played. In each treasure box, an award or the like the player may win is contained. On the display screen 2, treasure boxes 21 to 23 attached with sequential numbers of 1 to 3 are displayed. The gaming machine is configured such that if the player selects the treasure boxes in this sequence, he/she can win a high amount of award. As described, the gaming machine assists the player in the selection sequence such that the player can win the high amount of award.

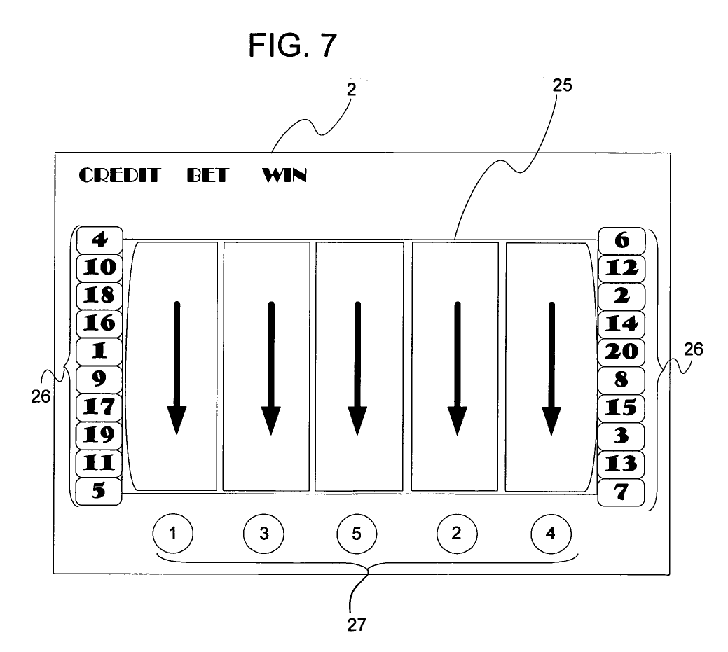

FIG. 7 is a diagram illustrating an example of an assistant indicating a sequence in which a player had better make selections. FIG. 7 illustrates the display screen 2. On the display screen 2, reels 25, lines 26, and reel stop buttons 27 are displayed. There are five reel stop buttons 27, which are respectively attached with sequential numbers. The gaming machine is configured such that if the player pushes the buttons according to the sequential numbers attached to the buttons to stop the reels 25, a winning combination may be achieved on any of the lines 26 to thereby, for example, pay back an award or start a bonus game. As described, the gaming machine assists the player in the sequence in which the player stops the reels.

In FIGS. 6 and 7, the specific examples of the assisting method that indicates the sequence in which the player had better make selections are described; however, the present invention is not limited to these examples, but may be in any configuration if the configuration assists the player. For example, in FIG. 6, the number of objects (treasure boxes, etc.) to be selected by the player may be any number. The number of objects to be selected may be, for example, two, or four or more. The number of objects to be selected and that of the sequential numbers for assisting the player do not necessarily coincide with each other. For example, there may be a case where the number of objects to be selected is four, but the sequential numbers according to which the player had better make selections may be only displayed on three of them. A way to display the sequence may be any one. For example, “first”, “second”, and “third” may be displayed on the objects. Also, as displayed on sides of a dice, black circles may be used to indicate numbers, by which the selection sequence can be found. Instead of the black circles, one or a plurality of some symbols or pictures may be displayed on the objects to find the selection sequence. Some configurations, i.e., the object is not the treasure box, but may be anything; the number of objects may be any number; the objects are not regularly arranged but may be arranged in any form; etc., are the same as those described above.

On the other hand, in FIG. 7, for example, the number of reels 25 may be any number. The number of reels may be seven, or three. Also, the number of reel stop buttons 27 may be any number. The number of reel stop buttons 27 may be set to be equal to that of the reels 25. For example, if there are seven lanes for the reels, seven reel stop buttons may be present, on which sequential numbers of 1 to 7 are respectively displayed to prompt the player to push the buttons according to the sequential numbers. The number of sequential numbers indicating the player the selection sequence does not have to be the same as that of the reel stop buttons. For example, the number of reel stop buttons is seven, but the number of sequential numbers indicating the player the selection sequence may be five, i.e., 1 to 5. What the player pushes to stop the reel is not necessarily the reel stop button, but may be anything. For example, what (an object) the player pushes to stop the reel may be of a triangular or star shape. The object may be one configured to be just displayed on the screen, and stop the reel if being touched by the player. A direction in which the reel rotates is not limited, but the reel may rotate in any direction. For example, the reel may rotate vertically, or horizontally, or obliquely.

The object to be selected by the player may be present in a place that is other than those corresponding to the reels and apart from the reels. Also, the object may be attached with the sequential number according to which the player had better make a selection. The number of lines 26 may be any number. The gaming machine may be configured such that the case where the player can win an award or the like is not limited to one where the winning combination is achieved on any of the lines but is any one. For example, the gaming machine may be configured such that if a predetermined symbol appears in a place other than those on any of the lines, the award or the like can be won.

The method for indicating the player the object selection sequence may include any one, besides the above-described methods. The sequence in which the player had better make selections may be indicated by, for example, voice. Alternatively, the sequence in which the player had better make selections may be indicated by, for example, light. The method may be configured such that, for example, one object first lights, and if the player selects the object, a next object lights. In this manner, the sequence in which the player selects objects may be guided. Also, what the player can win if he/she plays a game according to the sequence is not limited to the high amount of award, but may be anything. For example, it may be anything described above, such as the bonus game.

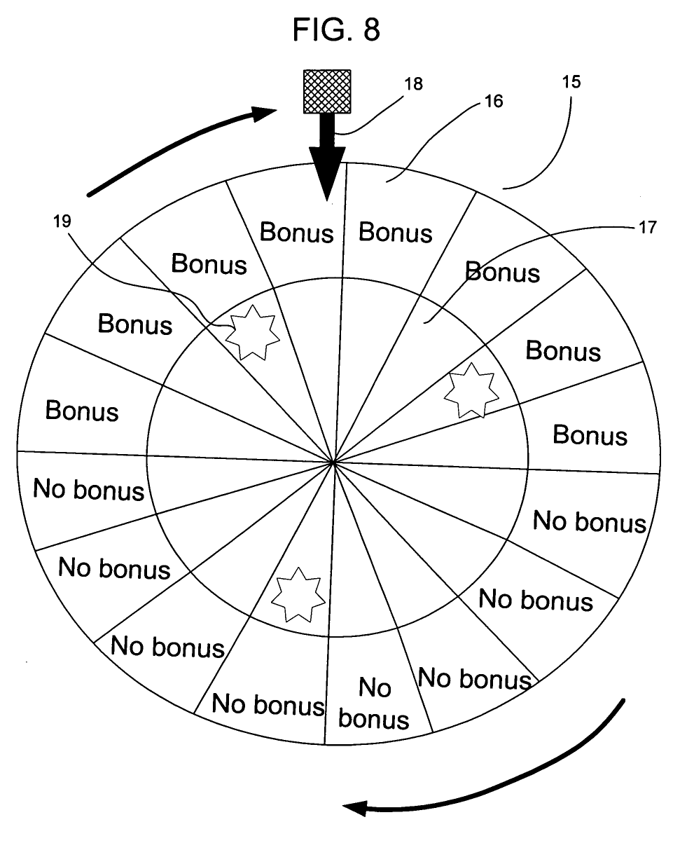

Next, a function of the gaming machine to assist a player in a timing at which the player had better make a selection is described. FIG. 8 is a diagram illustrating an example of an assistant indicating the timing at which the player had better make a selection. FIG. 8 illustrates a wheel 15 and an arrow 18. The wheel 15 substantially consists of an outer frame 16 and inner frame 17. The wheel 15 and arrow 18 are used to play a roulette game. Within the outer frame 16, “Bonus” and “No bonus” displays are provided. It is determined whether or not the player can enter a bonus game, on the basis of whether or not the arrow 18 indicates any of the “Bonus” displays within the outer frame 16 when the wheel 15 stops after rotation of the wheel 15 followed by a player's stop instruction. Any of star marks 19 displayed within the inner frame 17 indicates a timing at which the player issues the stop instruction. That is, the gaming machine is configured such that if the player issues the stop instruction when any of the star marks 19 reaches a place indicated by the arrow 18 after the wheel 15 has started rotating, the arrow 18 indicates any of the “Bonus” displays when the wheel 15 stops. In this manner, the gaming machine may assist the player in the stop instruction timing.

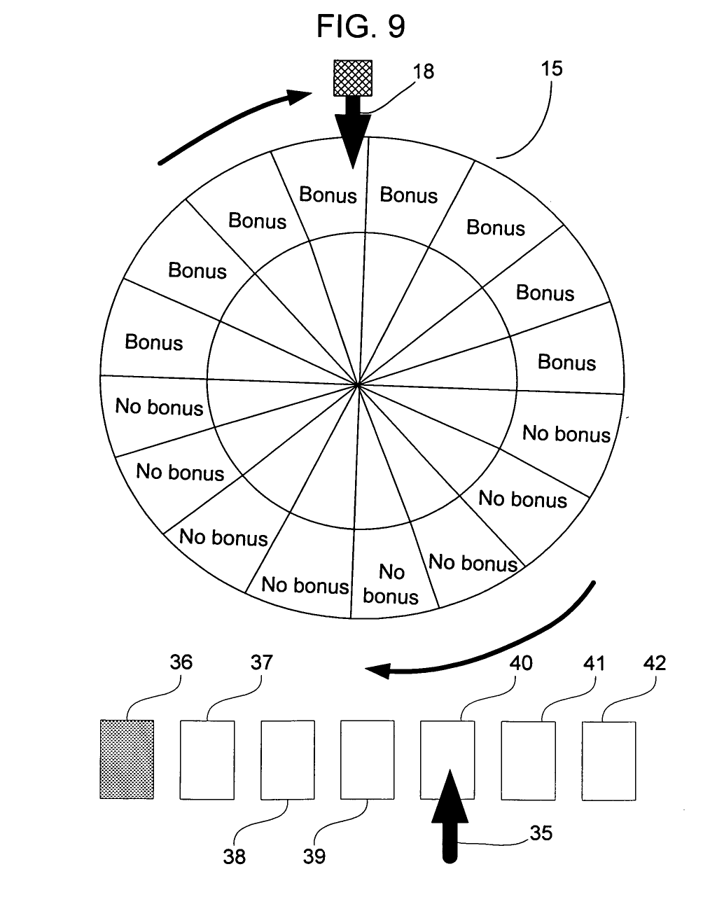

FIG. 9 is a diagram illustrating an example of an assistant indicating a timing at which a player had better make a selection. FIG. 9 illustrates a wheel 15 and an arrow 18. On the wheel 15, “Bonus” and “No bonus” displays are provided. The gaming machine is configured such that if the player issues a stop instruction, the wheel 15 begins to stop, and will stop after a certain period of time. It is determined whether or not the player can enter a bonus game, on the basis of whether or not the arrow 18 indicates any of the “Bonus” displays when the wheel 15 stops. Below the wheel 15, a plurality of fluorescent plates 36 to 42 and an arrow 35 for indicating the timing at which the player had better issue the stop instruction are displayed. The arrow 35 is fixed onto the fluorescent plate 40, and indicates the best place for the player to issue the stop instruction. The fluorescent plates 36 to 42 starts lighting from the leftmost fluorescent plate 36, and then lights in ascending order, i.e., from the fluorescent plate 37, to 38, etc. The gaming machine is configured such that a timing at which the fluorescent plate 40 lights corresponds to the best one at which the player issues the stop instruction. That is, the gaming machine is configured such that if the player issues the stop instruction when the fluorescent plate 40 lights, the arrow 18 indicates any of the “Bonus” displays when the wheel 15 stops.

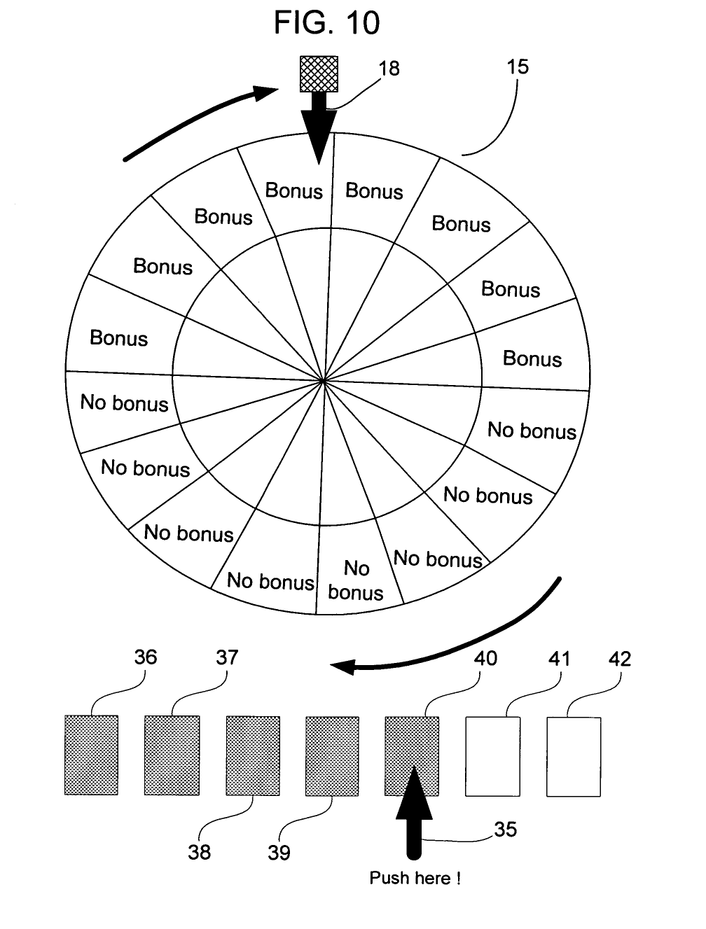

FIG. 10 is a diagram illustrating the example of the assistant indicating the timing at which the player had better make a selection. FIG. 10 corresponds to FIG. 9 after a certain period of time. FIG. 10 illustrates a state where the fluorescent plates 36 to 40 light after they have started lighting sequentially from the left, i.e., beginning with the fluorescent plate 36. This state corresponds to the best timing at which the player issues the stop instruction. Below the arrow 36, “Push here!” is displayed to prompt the player to issue the stop instruction at this timing. The player may be assisted in the operating timing in this manner.

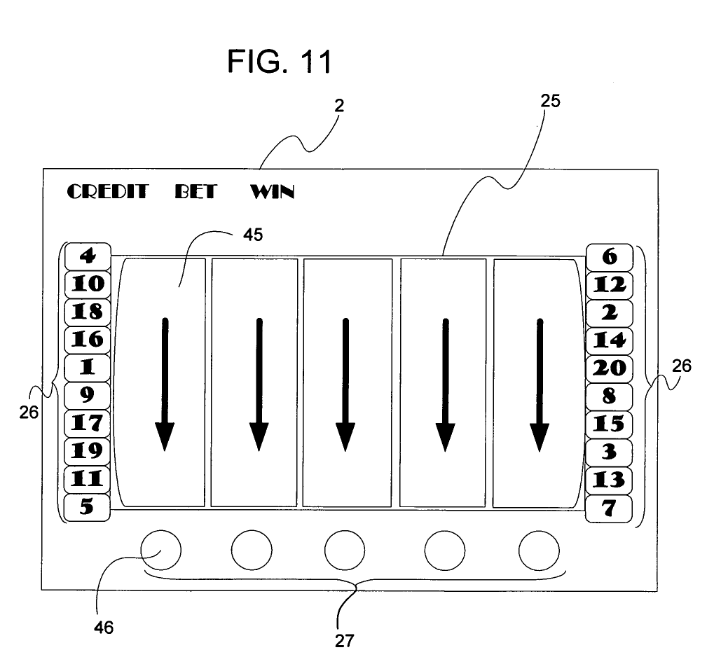

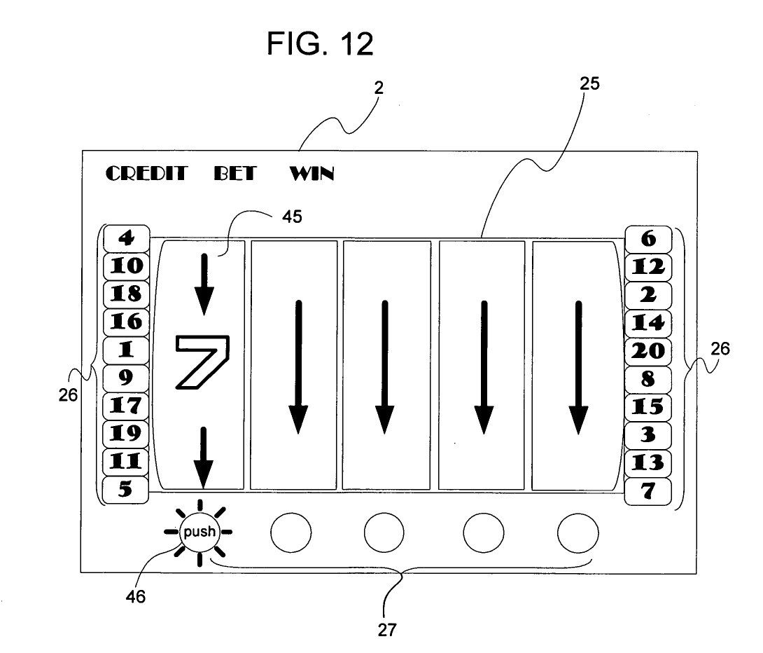

FIGS. 11 and 12 are diagrams illustrating an example of an assistant indicating a timing at which a player had better make a selection. FIG. 11 illustrates the display screen 2. On the display screen 2, reels 25, lines 26, and reel stop buttons 27 are displayed. FIG. 11 illustrates a normal state where the reels rotate. FIG. 12 illustrates a method for assisting the player in the timing at which the player had better make a selection in the reel game illustrated in FIG. 11. In FIG. 12, every time a symbol “7” is displayed on the leftmost column 45 of the reels 25, the reel stop button 46 displays “push” and simultaneously lights to thereby inform the player that the player had better push the reel stop button 46 when the symbol “7” is displayed on the reel 45. The gaming machine may be configured such that, for example, if the player pushes the reel stop button 46 at this timing, the symbol “7” for paying back a high amount of award is stopped on any of the lines 26.

In FIGS. 8 to 12 described above, the specific examples of the assisting method that indicates the timing at which the player had better make a selection are described; however, the present invention is not limited to these examples, but may be in any configuration if the configuration assists the player. For example, in FIG. 8, what informs the player of the best timing is not the star mark, but may be any object. For example, the object may be a picture of some sort of character, diamond, animal, household article, car, or the like. Also, a predetermined frame on the wheel may be painted some color, or blinked to inform the player of the best timing. The number of objects (star marks, etc.) may be any number. For example, the number of objects may be a small number such as two or four, or a large number such as ten.

Also, in FIGS. 9 and 10, for example, the number of fluorescent plates may be any number. The number of fluorescent plates may be a small number such as three, or a large number such as ten or more. The sequence in which the fluorescent plates light is not from left to right, but may be arranged in any direction. For example, the sequence in which the fluorescent plates light may be from right to left, or in a vertical direction. Some sort of object may be used instead of the fluorescent plate if the object is movable. For example, the assistant may be some sort of character prompting the player to make a selection at a timing when the some sort of character moving on a display screen being provided reaches a predetermined place. Alternatively, the assistant may be some movable object being displayed, such as an airplane, car, or train, which prompts the player to make a selection at the timing when the some movable object reaches the predetermined place. A location of the indicator (e.g., arrow 35, etc.) indicating the predetermined place is not limited to the one illustrated in the diagrams, but may be any one. For example, the arrow 35 may indicate the rightmost fluorescent plate.

Also, in FIGS. 8 to 10, for example, the indicator (arrow 18 or 35) indicating the predetermined place may be any one. For example, the indicator indicating the predetermined place may be of a handshape with a forefinger being raised. Also, for example, some display such as “Push here” may be provided in the predetermined place. Further, the player may be informed of the selection timing by voice or the like. The wheel 15 has not only the outer and inner frames 16 and 17, but may have any frames. For example, the wheel 15 may further have a plurality of middle frames between the outer and inner frames. Within any of the frames of the wheel 15, any display may be provided. For example, a ratio between the number of “Bonus” displays and that of “No bonus” displays displayed on the wheel 15 may be any one. Also, on the wheel 15, for example, graphics and pictures may be displayed rather than the “Bonus” and “No bonus” displays. The wheel 15 may be of any shape, and may be, for example, of a shape in which a central portion of the wheel is hollowed out.

The arrows 18 and 35 may be replaced by anything, and the predetermined place may be indicated by, for example, a ball, arrow, star, or the like. The arrow is not necessarily fixed, but may be movable on an outer circumference of the wheel with respect to the wheel being fixed, and indicate some place on the wheel. The indicator (arrow 18, etc.) indicating the predetermined place does not have to be one in number, but a plurality of indicators may be present to indicate a plurality of places. For example, two balls are sequentially thrown into the wheel to select two places. Also, the wheel is rotated to indicate two places with two arrows being fixed. Timings at which the plurality of places are selected with a plurality of arrows or the like may be the same or different.

Also, a shape of the wheel is not limited to a circular shape, but may be any shape. For example, the wheel may have a triangular or rectangular shape, and may rotate. Also, the number of wheels is not limited to one, but a plurality of wheels may be present. If there are the plurality of wheels, one place may be selected for each of the wheels, or a plurality of places may be selected for each of the wheels. Further, the number of frames of the wheel is not limited, but may be any number. For example, the outer frame of the wheel may substantially consist of thirty-six sub-frames, or four sub-frames.

Also, in FIGS. 11 and 12, a reel on which a specific symbol (such as “7”) for prompting the player to make a selection is displayed may be any of the reels, and the specific symbol may be displayed on the middle reel or right reel. Along with this, every time the specific symbol is displayed on the middle or right reel, the reel stop button located below the reel may be blinked or operated in another manner. The reel stop button may be arbitrarily located, and may be provided, for example, above the reel. The number of reels for prompting the player to make selections may be any number. For example, only one of the five reels may inform the player of a selection timing. Alternatively, all of the existing reels may inform the player of selection timings. The sequence in which the player is prompted to make selections is not necessarily from the left. For example, the player may be prompted to make selections of the existing reels in a random sequence, or in a sequence from the right. The gaming machine may be configured such that the case where the player can win an award or the like is not limited to one where the winning combination is achieved on any of the lines, but may be any one. For example, the gaming machine may be configured such that if a predetermined symbol appears in a place other than those on any of the lines, the award or the like can be won.

Also, some configurations, i.e., the numbers of lines, reels, and reel stop buttons may be any numbers; what the player pushes to stop the reel may be anything; a rotation direction of the reel may be any direction; etc., are the same as those described with FIG. 7 Further, an advantage the player can obtain if he/she timely performs an operation is not limited to the payback of an award, or the entrance into the bonus game, but may be anything, and may be the same as any of those described with FIGS. 2 to 7.

Next, the flag function of the gaming machine according to the present invention is described. The flag function refers to a function of performing a drawing inside the gaming machine, or in other location, with or without relation to an operation by a player, and if an outcome of the drawing is winning, stocking the winning outcome inside the gaming machine. Subsequently, for example, the gaming machine may inform the player of the internal winning in some form, and provide a profit (payback, bonus game, etc.) from the winning to the player if the player performs some sort of operation.

A place where the drawing is performed is not necessarily the inside of the gaming machine, but may be any place. For example, the drawing may be performed in a host connected to the gaming machine, or in a device provided outside the gaming machine. Also, after the gaming machine has stocked the winning outcome, it may provide the profit from the winning to the player without informing the player of the internal winning if the player performs some sort of operation. Alternatively, after the gaming machine has stocked the winning outcome and then informed the player of the internal winning, it may provide the profit from the winning to the player without any operation by the player. Still alternatively, after the gaming machine has stocked the winning outcome, it may provide the profit from the winning to the player without informing the player of the internal winning and further without any operation by the player. If the profit from the winning is provided to the player without any operation by the player, for example, the profit from the winning may be adapted to be provided to the player after a predetermined period of time with the provision being made dependent on time, or the profit from the winning may be adapted to be provided to the player with the provision being made dependent on an element other than the player.

A place where the winning outcome is stocked is not necessarily the inside of the gaming machine, but may be any place. For example, the stocking place may be the host connected to the gaming machine, or the device provided outside the gaming machine. The profit from the winning to be provided to the player may be anything. For example, the profit from the winning may be an award, right to move to a special game (bonus game, progressive game, free game, etc.), coupon ticket usable in a restaurant, shop, movie theater, or the like, point, admission ticket, or the like.

The number of winning outcomes stockable inside the gaming machine or in other location may be any number. If a plurality of winning outcomes are stocked inside the gaming machine or in other location, a method for paying a winning award or the like back to the player may be any one. For example, every time the player performs a predetermined operation, an award that is worth one winning outcome, or the like may be paid back. Alternatively, for example, if the player performs the predetermined operation, a total award amount that is worth a plurality of stocked winning outcomes may be paid back to the player at once. The type of the winning outcomes stocked inside the gaming machine or in other location may be any one. For example, there may be a winning outcome employing a system in which an award is paid back on a portion-by-portion basis every time a predetermined period of time elapses.

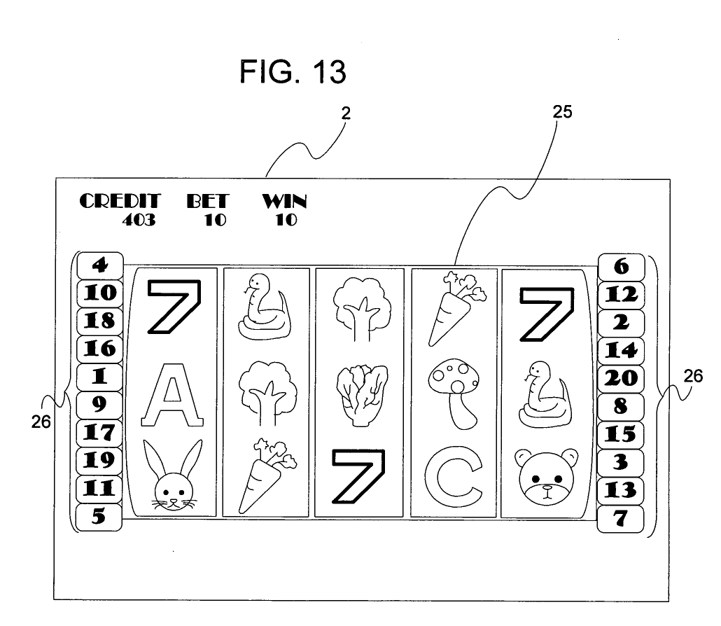

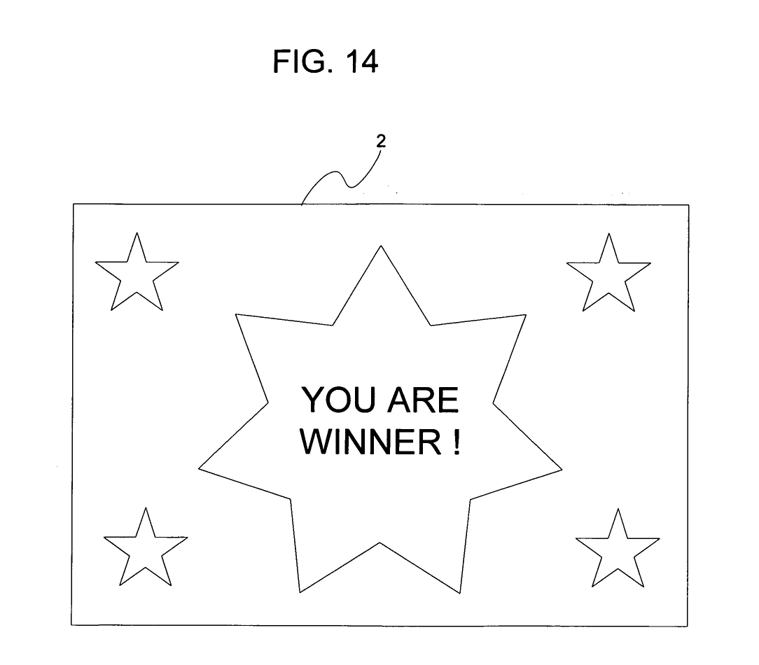

Next, a method for informing the player of the internal winning is described with the use of FIGS. 13 and 14. FIG. 13 is a diagram illustrating an example of the method for informing the player of the internal winning. FIG. 13 illustrates the display screen 2. On the display screen 2, reels 25 and lines 26 are displayed. On the reels 25, a plurality of symbols are illustrated. The player takes a look at an arrangement of the plurality of symbols displayed on the reels 25 to be able to determine whether or not he/she wins inside the gaming machine or in other location. For example, symbols “7” are displayed in the upper left, lower middle, and upper right portions of the area for displaying the reels 25, respectively, and the reels are configured to be stopped in such symbol arrangement if the player wins inside the gaming machine or in other location. The player can preliminarily obtain such information from somewhere (such as a gaming machine related magazine, or instruction manual of the gaming machine obtainable in a casino or the like), and if such arrangement is made, the player can be convinced of the internal winning.

The arrangement of the symbols on the reels, which informs the player of the internal winning, may be any one. For example, the arrangement may be one in which the symbols “7” are displayed on the reels in a spiral form. Alternatively, for example, the arrangement may be one in which all symbols displayed on the reels represent “7”. The symbol used for informing of the internal winning is not the symbol “7”, but may be any one. Also, instead of the use of the symbols, some sort of image may be displayed on the reels to inform the player of the internal winning.

FIG. 14 is a diagram illustrating an example of the method for informing the player of the internal winning. FIG. 14 illustrates the display screen 2. On the display screen 2, a display of “You are winner!” is provided, by which the player can be convinced at a glance that he/she wins inside. As described, by displaying an image or characters on the display screen, the player may be informed of the internal winning, and also a presentation may be made more comprehensible to the player and more active. It should be appreciated that the image displayed on the display screen is not limited to that illustrated in FIG. 14, but may be any one. For example, the gaming machine may be configured such that a character appears on the display screen, then starts fighting, and wins the fight if the player wins inside. Also, for example, the gaming machine may be configured such that a plurality of objects are displayed on the display screen, then the player is made to select some of the objects, and a display indicating the winning is provided to the player if the player wins inside.

Also, there may be any method for informing the player of the internal winning, in addition to the methods described with FIGS. 13 and 14. For example, sound may be used to inform the player of the internal winning. In this case, voice such as “You are winner!” may be outputted so as to be heard by the player to thereby inform him/her of the internal winning. Alternatively, light may be used to inform the player of the internal winning. In this case, the light may be emitted from the display screen, or any device other than the display screen, which is provided in the gaming machine. The type of the light may be any one, and a plurality of types of light may be blinked or operated in another manner. Still alternatively, a combination of sound, light, and image may be used to inform the player of the internal winning.

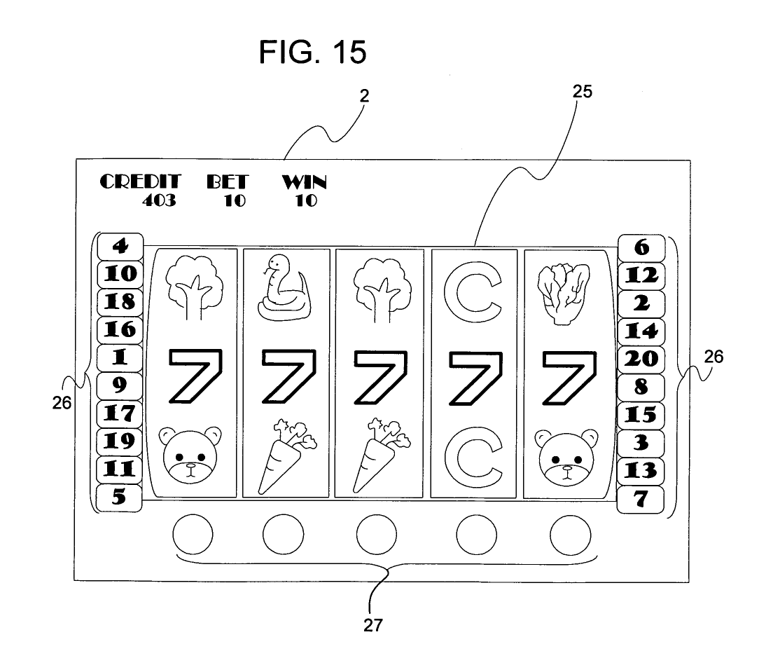

Next, some sort of operation required for the player, to pay back an award or the like, after the player has won inside the gaming machine or in other location is described. FIG. 15 is a diagram illustrating an example of the some sort of operation by the player. FIG. 15 illustrates the display screen 2. On the display screen 2, reels 25, lines 26, and reel stop buttons 27 are displayed. On the reels 25, a plurality of symbols are illustrated. FIG. 15 illustrates the reels being stopped by the player, and on the middle row of the reel displaying area, symbols “7” are horizontally arranged in a line. If the symbols “7” are arranged on any of the lines 26 as described, the award due to the internal winning may be paid back to the player.

The arrangement of the symbols required for the player, to pay back the award or the like, is not limited to that illustrated in FIG. 15, but may be any one. For example, the arrangement of the symbols may be one in which the symbols “7” are arrayed on a zigzag line, or arrayed in a V shape. Also, the gaming machine may be configured such that the symbols “7” are not necessarily arranged on all of the reels used in the gaming machine, but the award or the like is paid back if, for example, the symbols “7” are arranged on three of the five reels. The symbol used for the symbol arrangement is not the symbol “7”, but may be any symbol.

Also, there may be any operation the player should perform to obtain the award or the like due to the winning, in addition to the operation described with FIG. 15. For example, the gaming machine may be configured to comprise a lever or switch, and pay back the winning award or the like if the lever or switch is used. Alternatively, the gaming machine may be configured to pay back the award or the like if a predetermined hand is achieved in the card game. Still alternatively, the gaming machine may be configured to pay back the award or the like if the wheel is stopped at a predetermined position in the roulette game.

Also, some configurations in FIGS. 13 to 15, i.e., the numbers of lines, reels, and reel stop buttons may be any numbers; what the player pushes to stop the reel may be anything; a rotation direction of the reel may be any direction; etc., are the same as those described with FIG. 7. Further, there may be any number of symbols, and also there may be any symbol type.

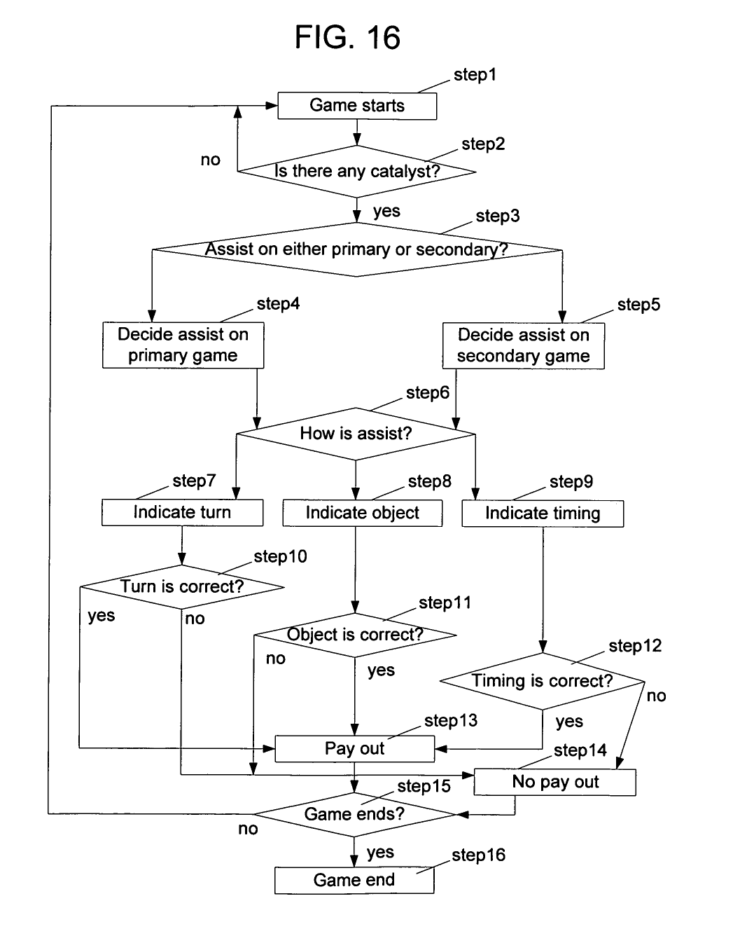

Next, a game flow performed by the gaming machine of the present invention is described. FIG. 16 is an example of a flowchart for the gaming machine having the assist function. In FIG. 16, after the game has been first started (step 1), it is determined whether or not there is some catalyst for assisting a player (step 2). The some catalyst herein may be anything. The some catalyst may be, for example, to start a predetermined action (any of the actions, or the like, described above with FIGS. 2 to 12, such as to select any of the objects, and to stop the wheel in the roulette game) in a bonus game. Alternatively, the some catalyst may be, for example, some case dependent on an operation by the player. The some case dependent on an operation by the player may be, for example, the case where the player achieves the winning combination in the slot game. Alternatively, the some case dependent on an operation by the player may be, for example, the case where the player performs some sort of operation to be assisted by the gaming machine. When such operation is performed, the gaming machine may starts assisting the player.

In step 2, if it is determined that there is some catalyst, it is determined whether or not an operation by the player is assisted in any of a primary or secondary game (step 3). Subsequently, a decision to give the assist in the primary game (step 4) or in the secondary game (step 5) is made. In step 2, if it is determined that there is no catalyst, the game is started again (step 1). Note that the game mode in which the assist is given is not limited to the primary or secondary game, but the assist may be given in any game mode. For example, there may be a third game, or the like, in which the assist is given. Alternatively, the game mode in which the assist is given is not selected, but the assist may be given in a predetermined game mode.

After the decision to give the assist in any of the game modes has been made, it is decided how the player is assisted (step 6). The method for assisting the player is not particularly limited, but may be any one including a method for assisting the player in, for example, the selection sequence, object selection, or timing. If it is decided to assist the player in the selection sequence, the sequence in which the player had better make selections is indicated in the game (step 7). Then, if the player makes the selections in the indicated sequence (step 10), an award or the like, for example, are paid back (step 13). If the player does not make the selections in the indicated sequence (step 10), the award or the like is not paid back (step 14).

On the other hand, if it is decided to assist the player in the object selection, an object the player had better select is indicated in the game (step 8). Then, if the player selects the object as indicated (step 11), the award or the like, for example, is paid back (step 13). If the player does not select the object as indicated (step 11), the award or the like is not paid back (step 14). Alternatively, if it is decided to assist the player in the operating timing, a timing at which the player had better perform an operation is indicated in the game (step 9). Then, if the player performs the operation at the timing as indicated (step 12), the award or the like, for example, is paid back (step 13). If the player does not perform the operation at the timing as indicated (step 12), the award or the like is not paid back (step 14).

The gaming machine may be configured to select the assisting method from the above three configurations, or may be configured in any other manner. For example, the gaming machine may be configured to select the assisting method, not based on any of the three elements such as the object selection and timing, but based on any of only two elements. Also, the gaming machine may be configured to select the assisting method based on any of four or more elements. Further, the type of the assisting method cannot be selected, but a predetermined assisting method may be applied. Still further, a profit received by the player when the player performs the operation according to the assist is not limited to the award, but may be, for example, anything as described above.

In either case where the award or the like is paid back (step 13), or the award or the like is not paid back (step 14), the following step is to determine whether or not the game is ended (step 15). If it is determined that the game is not ended, the game is again started (step 1). If it is determined that the game is ended, the game is ended (step 16).

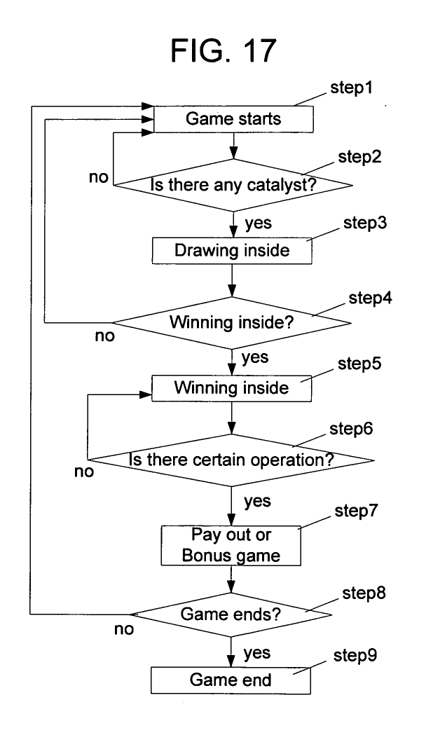

FIG. 17 is an example of a flowchart for the gaming machine having the flag function. In FIG. 17, after the game has been first started (step 1), it is determined whether or not there is some catalyst for performing an internal drawing (step 2). The some catalyst herein may be any type of catalyst. The some catalyst may be one relevant or irrelevant to an operation by the player. The operation by the player may be any operation such as an operation by the player to display a predetermined symbol on the reel, or to issue the instruction to stop the wheel at the predetermined position in the roulette game. Also, the case irrelevant to the operation by the player may be any case such as one where a predetermined number of plays of the game is performed, or a predetermined period of time elapses. If the operation by the player is performed, or a predetermined action is taken, the internal drawing may be started (step 3).

After the internal drawing has been started, it is determined whether or not winning occurs (step 4). If the winning occurs, the internal winning is fixed (step 5). If the winning does not occur, the flow returns to the beginning of the game (step 1). After the internal winning has been fixed, it is determined whether or not a certain operation has been performed to provide a profit from the winning to the player (step 6). The certain operation herein may be any one as described with the use of FIG. 15. If it is determined that the certain operation has been performed, an award or the like is paid back to the player (step 7). On the other hand, if it is determined that the certain operation has not been performed, the award or the like is not paid back, and the winning outcome is stocked inside the gaming machine. If the award or the like is paid back, it is determined whether or not the game is ended (step 8). If it is determined that the game is not ended, the game is again started (step 1). On the other hand, if it is determined that the game is ended, the game is ended (step 9).

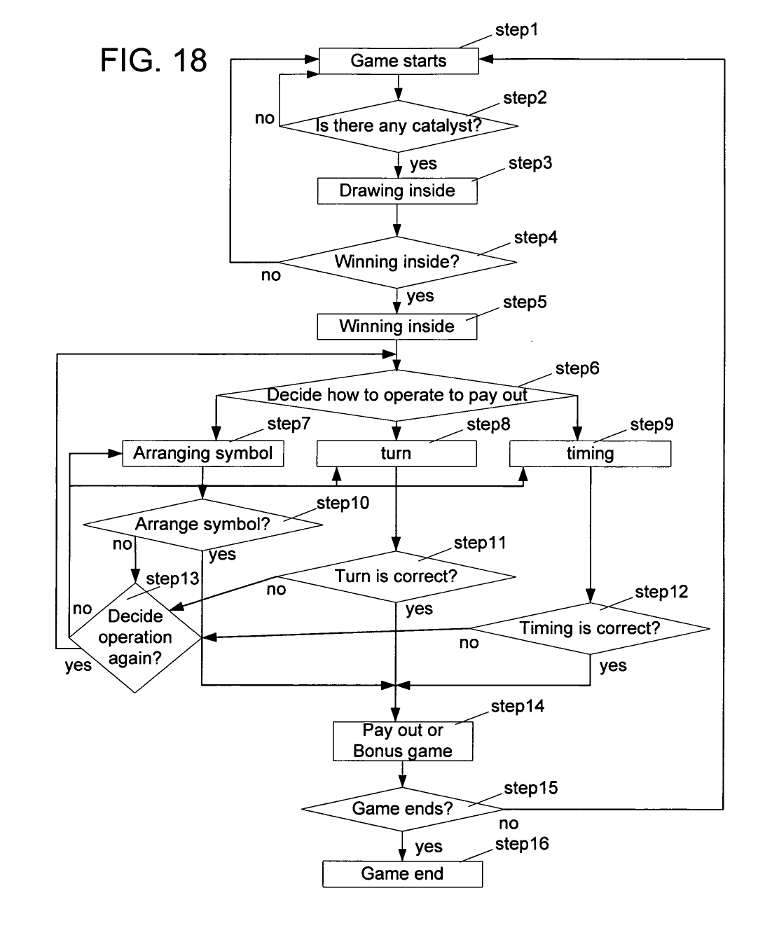

FIG. 18 is another example of the flowchart for the gaming machine having the flag function. In FIG. 18, in steps 1 to 5, operations same as those described with FIG. 17 are performed. After the internal winning has been fixed, it is decided what kind of operation should be performed to pay back an award or the like (step 6). If it is decided that the award or the like is paid back and if an operation for arranging symbols has been performed (step 7), it is determined whether or not the symbols have been arranged (step 10). If the symbols have been arranged, the award or the like is paid back (step 14). On the other hand, if it is decided that the award or the like is paid back and if an operation according to a sequence has been performed (step 8), it is determined whether or not the operation according to the sequence has been performed (step 11). If the operation according to the sequence has been performed, the award or the like is paid back (step 14).

Alternatively, if it is decided that the award or the like is paid back and if an operation has been performed at a correct timing (step 9), it is determined whether or not the operation has been performed at the correct timing (step 12). If the operation has been performed at the correct timing, the award or the like is paid back (step 14). The operation necessary to pay back the award or the like is not limited to any of these three operations, but may be one of any number of operations. The number of possible operations is not necessarily three, but may be any one or two of the three. After the award or the like has been paid back (step 14), it is determined whether or not the game is ended (step 15). If it is determined that the game is not ended, the game is again started (step 1). On the other hand, if it is determined that the game is ended, the game is ended (step 16).

If the operation having been decided to be necessary to pay back the award or the like has not been performed, it is determined whether or not the type of the necessary operation is again decided (step 13). If the operation is not decided again, it is continuously determined without change whether or not the necessary operation has been performed (steps 7, 8, and 9). If the operation is decided again, it is again decided what kind of operation should be performed to pay back the award or the like (step 6).

As above, the present invention is specifically described with the use of the plurality of drawings and flow chart; however, it goes without saying that the present invention is not limited to such description, but as far as an embodiment has an essential part of the present invention, the embodiment falls within the scope of rights of the present invention even if it is embodied in any configuration. For example, in addition to the above-described embodiments, any types of game configurations may be present. For example, in the card game, if the player picks a card while the cards are shuffled, or some of the cards are moved, the player may be assisted in a timing allowing him/her to pick a better card. Also, there may be a game where a timing is taken in time to music. Such game may be, for example, in a form of a music game commercially available for the use of a TV game or the like. In this case, the music game may be played with the use of an electronic device having a shape of a guitar, drum, piano, or the like. Also, the gaming machine may be configured to set to approximately 1% or more a difference in profit percentage between players having been assisted and not having been assisted. Further, the gaming machine of the present invention may comprise both of the above-described assist and flag functions.

What is claimed is:

1. A gaming machine for providing a game after betting and for paying out an award according to a play result, comprising:
an initiator, which executes the game;
an assistant unit, which helps a play in the game; and
a storage device, which preserves the award as credits over 60.

2. The gaming machine of claim 1, wherein the initiator executes the game for selecting an object and the assistant unit indicates a certain area including the object to help the player select the object.

3. The gaming machine of claim 1, wherein the initiator executes the game for selecting an object and the assistant unit indicates a certain object to get a better award for the player.

4. The gaming machine of claim 1, wherein the initiator executes the game for selecting an object and the assistant unit indicates a better sequence that the player selects.

5. The gaming machine of claim 1, wherein the initiator executes a reel game with a plurality of reels and the assistant unit indicates a better sequence of the reel that the player stops.

6. The gaming machine of claim 1, wherein the assistant unit helps the play by making a sound, emitting a light or displaying an image.

7. The gaming machine of claim 1, wherein the difference of margin percentage between the award resulting from helping of the assistant unit and the award without help of the assistant unit is about more than 4%.

8. The gaming machine of claim 1, wherein the initiator executes a card game or a roulette game and the assistant unit helps the play in the card game or the roulette game.

9. The gaming machine of claim 1, wherein the initiator executes a primary game and a secondary game and the assistant unit helps the play in the primary game.

10. A gaming machine for providing a game after betting and for paying out an award according to a play result, comprising:
an initiator, which executes the game demanding an operation for playing the game; and
an assistant unit, which helps a timing to operate in the game.

11. The gaming machine of claim 10, wherein the initiator executes a reel game demanding to stop a reel and the assistant unit helps a timing to stop the reel.

12. The gaming machine of claim 10, wherein the initiator executes a roulette game demanding to stop a roulette and the assistant unit helps a timing to stop the roulette.

13. The gaming machine of claim 10, wherein the initiator executes a card game demanding to draw a card and the assistant unit helps a timing to draw the card.

14. The gaming machine of claim 10, wherein the assistant unit helps the timing by making a sound, playing music, emitting a light or displaying an image.

15. The gaming machine of claim 10, wherein the assistant unit helps the timing while playing the music.

16. A gaming machine for providing a game and paying out an award, comprising:
a judgment, which judges whether there is a player's winning inside the gaming machine or not;
an announce unit, which declares the player's winning inside the gaming machine;
a processor, which evaluates whether the gaming machine receives a certain operation from the outside or not, after declaring the player's winning; and
a payout unit, which pays the award outside the gaming machine in case the gaming machine receives the certain operation.

17. The gaming machine of claim 16, wherein the certain operation is to arrange a winning combination in the game, and the payout unit pays the award outside the gaming machine in case the gaming machine receives the winning combination.

18. The gaming machine of claim 17, wherein the game is a reel game or a card game.

19. The gaming machine of claim 16, wherein the certain operation is to be adapted a sequence selecting objects to an indicated sequence in the game, and the payout unit pays the award outside the gaming machine in case the selecting sequence adapts to the indicated sequence.

20. The gaming machine of claim 19, wherein the game is a game selecting objects like treasure, weapon or the other objects.

21. The gaming machine of claim 16, wherein the certain operation is to be adapted a timing selecting objects to an indicated timing in the game, and the payout unit pays the award outside the gaming machine in case the selecting timing adapts to the indicated timing.
